(19) United States
(12) Patent Application Publication
(10) Pub. No.: US 2013/0180112 A1
(43) Pub. Date: Jul. 18, 2013

(54) ROTARY ELECTRIC SHAVER

(71) Applicant: IZUMI PRODUCTS COMPANY, Matsumoto (JP)

(72) Inventor: Hideaki KOIKE, Matsumoto (JP)

(73) Assignee: IZUMI PRODUCTS COMPANY, Matsumoto (JP)

(21) Appl. No.: 13/739,380

(22) Filed: Jan. 11, 2013

(30) Foreign Application Priority Data
Jan. 12, 2012 (JP) 2012-3966

(51) Int. Cl. B26B 19/14

(52) U.S. Cl. CPC B26B 19/145
USPC 30/43.5

(57) ABSTRACT

A rotary electric shaver includes an outer cutter case secured to the outer periphery of an outer cutter and having a sliding surface formed on the outer periphery. An outer cutter case holder is fitted in a mounting port to vertically move with an upper limit position restrained and pivotably holds the outer cutter case to guide the sliding surface. A pushup plate imparts an upward return tendency to an outer cutter case assembly including the outer cutter, the outer cutter case and the outer cutter case holder. The outer periphery of the outer cutter case is provided with a projection extending to the upper surface of the outer cutter frame, serving as a stopper which prevents the outer cutter case from sinking into the mounting port. This arrangement prevents the outer cutter from being caught by the inner edge of the mounting port and improves shaving performance.

### BACKGROUND OF THE INVENTION

1. Field of the Invention

The present invention relates to a rotary electric shaver in which outer cutter cases secured to the outer peripheries of outer cutters are fitted in an outer cutter frame retained at an upper portion of a main body such that the outer cutter cases are movable up and down and pivotable, and inner cutters are brought into resilient contact with the outer cutters from below and rotated.

2. Description of the Related Art

In this type of electric shaver, when substantially discoid outer cutters are pressed against skin with a high pressing force, the outer cutters tend to deeply sink into the skin, undesirably causing excessively deep shaving or an excessive pressure of contact between the outer rims of the outer cutters and the skin, possibly resulting in discomfort of the user of the shaver. As a solution thereto, it has conventionally been proposed to surround the outer peripheries of the outer cutters by cutter circumferential rims (skin supporting rims) so as to prevent the contact pressure between the outer cutters and the skin from becoming excessive (refer to JP 09-503424T (corresponding to U.S. Pat. No. 5,625,950)).

In the rotary electric shaver disclosed in the aforesaid patent document, the cutter circumferential rims (skin supporting rims) are movably held with respect to holders (outer cutter frames), and the outer cutters are movably held with respect to the cutter circumferential rims. When the outer cutters are brought into firm contact with the skin, the skin around the outer cutters depresses the cutter circumferential rims, so that the contact pressure is distributed between the outer cutters and the cutter circumferential rims, thus reducing the contact pressure applied to the outer cutters.

However, the rotary electric shaver disclosed in JP 09-503424T (corresponding to U.S. Pat. No. 5,625,950) poses a problem in that, since the outer cutters are movable relative to the cutter circumferential rims, increasing the travel amounts (the sinking amounts or the pivoting amounts) of the outer cutters causes the edges of the outer cutters to be easily caught by the opening rims of an outer cutter mounting ports of the cutter circumferential rims. More specifically, the outer cutters are inserted from below into the outer cutter mounting ports of the cutter circumferential rims, and the flanges of the outer cutters engage the inner edges of the outer cutter mounting ports of the cutter circumferential rims. Therefore, firmly pressing the outer cutters against the skin causes the outer cutters to deeply dig into the cutter circumferential rims.

Each of the cutter circumferential rims circularly moves (pivots) relative to each of the outer cutter frames about an axis (denoted by K, A, A1 or A2), which passes the center of each of the outer cutters and which is parallel to the upper surface of each of the outer cutters. Hence, especially if each of the cutter circumferential rim were supported to circularly move about only one axis, then the skin supporting rim would not circularly move when a pressure is applied to the skin on the axis of this particular circular movement, resulting in an unsmooth shaving motion.

As a solution thereto, it has been proposed to secure each of the cutter circumferential rim (the outer cutter case) to each of the outer cutter and make the outer cutter case pivotable in all directions (refer to JP 2006-320459A (corresponding to U.S. Pat. No. 7,370,420 (B2) and EP 1724073A1). FIG. 12 illustrates the construction disclosed in this patent document, in which FIG. 12(A) is a plan view of the construction, and FIG. 12(B) and FIG. 12(C) are sectional diagrams at line B-B. FIG. 12(B) illustrates the return position of an outer cutter 2 and FIG. 12(C) illustrates the outer cutter 2 in a tilted state. In these drawings, the bottom surface of a substantially bowl-shaped pivot case 4, to which the outer cutter 2 is secured, is formed into a substantially spherical shape, and the spherical bottom surface is pivotably held by a cutter receiving plate (not shown) that has a substantially mortar-shaped sliding surface while restraining the vertical travel thereof. The pivot case 4 is provided with a return tendency toward a center by a conical coil spring 6.

There has also been proposed a construction in which a cutter circumferential rim secured to the outer periphery of the outer cutter is provided with a pair of engaging hooks protruding downward, and the distal ends of the engaging hooks engage the bottom edge of the inner periphery of the mounting port of the outer cutter frame to pivot the cutter circumferential rim about a pivotal axis that passes the engaging hooks (refer to JP 2011-143101A (corresponding to US 2011-0173815A1 and EP 2345516A1)). In this case, the cutter circumferential rim is pushed up at a point on the central side of the outer cutter frame by an outer cutter float spring, and a drive shaft pushes up the vicinity of the center of the outer cutter through the intermediary of the inner cutter. Thus, a part of cutter circumferential rim made integral with the outer cutter, which part is adjacent to the center of the outer cutter frame, rises about the pivoting axis. The rising amount will be set by the height position at which the engaging hooks and the outer cutter frame are engaged and the height position at which a flange-shaped projecting portion provided on the outer periphery of the cutter circumferential rim comes in contact with the surface of the outer cutter frame.

In the construction disclosed in JP 2006-320459A (corresponding to U.S. Pat. No. 7,370,420(B2) and EP 2345516A1), when a part of the peripheral edge of the outer cutter 2 is firmly depressed by the skin and tilted, the pivot case 4 to which the outer cutter 2 is secured will sink while being considerably tilted as illustrated in FIG. 12(C). At this time, when the pivot case 4 descends beyond a mounting port 8 of an outer cutter frame 7, the skin will come in contact with the edge of the mounting port 8. This causes inadequate closeness of the skin to the outer cutter 2, resulting in deteriorated shaving performance. This has been posing a problem in that an insufficiently shaved skin area increases or deep shaving cannot be accomplished. There has been another problem in that the skin comes in firm contact with the mounting port 8 of the outer cutter frame 7, leading to poor protection of the skin or deteriorated feeling during the use of the shaver.

Further, an inner cutter is installed such that it can be brought into sliding contact with the bottom surface of the outer cutter 2. A drive shaft (not shown) pivotably engages a boss 9 of the inner cutter. The drive shaft imparts an upward return tendency to the inner cutter. The pivot case 4 is retained at a central position mainly by a resilient return force used by the drive shaft to push up the outer cutter 2 from below and a return force of a conical coil spring 6 that pushes up the cutter receiving plate. However, the return force for returning the pivot case 4 to the central position is weak, presenting a problem in that the pivot case 4 is unstably retained and therefore the feeling during the use of the shaver deteriorates.

In addition, according to the construction disclosed in JP 2011-143101A (corresponding to US 2011-0173815A1 and EP 2345516A1), each of the outer cutters is pivotably held by the outer cutter frame by the engaging hooks of the cutter circumferential rim, and positioned by abutting the projecting portion provided on the outer periphery of the cutter circumferential rim against the upper surface of the outer cutter frame in a stationary state. Hence, a portion of the cutter circumferential rim, which portion is on the outer periphery side of the outer cutter frame, does not descend at all, while only a portion thereof near the center of the outer cutter frame can be pushed in. For this reason, there have been cases where the outer cutter contact pressure near the outer periphery of the outer cutter frame becomes excessively high, whereas the contact pressure near the center of the outer cutter frame becomes excessively low, thus making it difficult to improve the feeling during the use of the shaver.

### SUMMARY OF THE INVENTION

The present invention has been accomplished under the circumstances as aforementioned, and it is an object of the invention to provide a rotary electric shaver that is capable of preventing outer cutters from being caught by the inner edges of mounting ports of cutter circumferential rims (outer cutter cases) when the outer cutters deeply sink, capable of improving shaving performance with improved closeness of outer cutters to skin, permitting smooth sinking of the outer cutters at any positions in a circumferential direction, and capable of significantly improving the feeling during the use of the shaver by providing substantially uniform and appropriate contact pressures of the outer cutters against the skin over the entire circumference.

According to the present invention, the aforesaid object is achieved by a rotary electric shaver with a plurality of cutter units, each of which has an outer cutter and an inner cutter, the respective outer cutter being pivotably held at a mounting port of an outer cutter frame held on a main body, and the respective inner cutter being urged upward and rotated by a drive shaft while being in resilient contact with the bottom surface of the outer cutter, the rotary electric shaver comprising:

an outer cutter case which is secured to an outer periphery of the outer cutter and which has a spherical sliding surface formed on a lower portion of the outer periphery of the outer cutter case;

an outer cutter case holder which is fitted in the mounting port to be vertically movable with an upper limit position thereof restrained and which pivotably holds the outer cutter case, guiding the spherical sliding surface of the outer cutter case; and

a pushup plate which imparts an upward return tendency to an outer cutter case assembly formed of the outer cutter, the outer cutter case, and the outer cutter case holder;

wherein the outer periphery of the outer cutter case is provided with a projection which extends out to an upper surface of the outer cutter frame so as to serve as a stopper which prevents the outer cutter case from sinking into the mounting port.

According to the present invention, the outer cutter is integrally secured to the outer cutter case (corresponding to a cutter circumferential rim), so that the outer cutter will not sink or turn (pivot) with respect to the outer cutter case. Hence, when only a part of the outer periphery of the outer cutter is firmly pushed in, the outer cutter will not considerably tilt to be caught by the mounting port of the outer cutter case. This permits improved closeness of the outer cutters to skin with resultant improved shaving performance. Further, the outer cutter can be pivoted in all directions (longitudinally and laterally) with respect to the outer cutter case holder, and the outer cutter case holder can be moved up and down by being guided by the inner surface of the mounting port of the outer cutter frame, thus allowing smooth sinking at any positions in the circumferential direction of the outer cutter. Thus, the contact pressure of the outer cutters applied to the skin can be substantially uniform and appropriate over the entire circumference, so that the feeling during the use of the shaver can be significantly improved.

The outer cutter case assembly combining the outer cutter and the outer cutter case into one piece is movably retained at the mounting port provided in the outer cutter frame. Hence, in the case where the shaver has a plurality of outer cutter case assemblies, the motions of adjoining outer cutter case assemblies do not interfere with each other, so that the shaving performance of adjoining outer cutters will not be affected. In addition, each outer cutter case assembly is independent, so that the motion of one outer cutter case assembly does not cause another outer cutter case assembly to move up or down or pivot, and the resistance during a vertical motion does not increase. Furthermore, since the outer cutter frame exists among outer cutter cases, even if the difference in height or tilt between adjoining outer cutters increases, the outer cutter frame interposed therebetween accommodates the difference, thus allowing a head to smoothly move. Thus, the need for hinges among outer cutter cases (refer to JP 09-503424A (corresponding to U.S. Pat. No. 5,625,950) is obviated, so that the diameters of the outer cutters can be increased to increase the shaving area. This means that increasing the diameters of the outer cutters will not lead to increased sizes of the outer cutter frames.

The outer cutter case may be provided with a plurality of engaging hooks extending downward, which is formed integrally with the outer cutter case, and the distal ends of the engaging hooks may engage the outer cutter case holder from below. This makes it possible to connect the outer cutter case with the outer cutter case holder in a vertical direction such that the outer cutter case is pivotable in all directions with respect to the outer cutter case holder. A construction for the outer cutter case holder to pivotally and vertically connect the outer cutter case can be accomplished by forming a substantially mortar-shaped sliding surface, with which the spherical sliding surface of the outer cutter case is in sliding contact, on an upper portion of the inner periphery of the outer cutter case holder and also forming a spherical sliding surface, with which the engaging hooks engage and which slides, on a lower portion of the outer periphery.

In the case where a plurality of cutter units is fitted in the outer cutter frame, each of the outer cutter cases of each of the cutter units may be provided with a pair of engaging hooks on a horizontal straight line which is orthogonal to a straight line, which passes the center of the outer cutter frame and which is parallel to the shaving surface (or the upper surface of the outer cutter), as observed in a plan view, each of the outer cutter cases may be pivotally connected to each of the outer cutter case holders about a straight line which passes the pair of the engaging hooks, and the projection is provided on an outer periphery side of the outer cutter frame of the outer cutter case. In this case, abutting the pushup plate against each of the outer cutter case holders on a central side of each of the outer cutter frames and pushing the outer cutter case holder up to the upper limit position thereof makes it possible to provide a sufficiently wide movable range of the outer cutter due to the combination of the vertical movable range of the outer cutter case holder and the vertical movable range of the pushup plate when the skin depresses the outer cutter on the central side of the outer cutter frame. When the skin comes in contact with the outer cutter and depresses the outer cutter on the outer peripheral side of the outer cutter frame, the outer cutter becomes vertically movable within the movable range of the outer cutter case holder. Thus, the feeling during the use of the shaver can be improved while protecting the skin at the same time.

In the case where three outer cutter case assemblies are retained by the outer cutter frame, the outer cutter case assemblies may be arranged such that the centers of the three outer cutters are positioned at the apexes of an equilateral triangle in relation to the center of the outer cutter frame. In the case where two outer cutter case assemblies are retained by the outer cutter frame, the outer cutter case assemblies may be arranged such that the centers of the outer cutters are positioned symmetrically with respect to the center of the outer cutter frame. The rotary electric shaver in accordance with the present invention is most desirably provided with three outer cutter case assemblies. Alternatively, however, the rotary electric shaver may include two or three or more outer cutter case assemblies.

The pushup plate, which pushes up each of the outer cutter case assemblies, is elastically supported upward by an outer cutter float spring compressively interposed between the pushup plate and the cutter retaining plate held by the outer cutter frame. A removable plate, which rotates about the central axis of the outer cutter frame (the axis which is perpendicular to the upper surface of the outer cutter frame or the shaving surface and which passes the center of the outer cutter frame), is held by the cutter retaining plate, so that the removable plate can be engaged with or disengaged from the inner surface of the outer cutter frame. For example, a projection provided on the peripheral edge of the removable plate may be disengageably locked onto to a fixing rib secured to (or integrally formed with) the outer cutter frame such that the projection is engaged or disengaged in the circumferential direction.

The cutter retaining plate retained by the inner surface of the cutter frame may be formed integrally with an inner cutter fall proof ring for preventing the inner cutter of each cutter unit from falling off. More specifically, the ring prevents the inner cutter from falling off the cutter unit when the head unit, in which the cutter unit has been installed to the outer cutter frame, is attached to or detached from the main body, thus ensuring easy installation and removal of the head unit.

The pushup plate preferably abuts against the bottom surface of the outer cutter case of the outer cutter case assembly at the central side of the outer cutter frame and resiliently pushes up the outer cutter case at the central side of the outer cutter frame. In this case, the outer cutter case may be arranged to be pivotable with respect to the outer cutter case holder and vertically connected thereto. This will cause the outer cutter case and the outer cutter case holder to ascend to the upper limit position of the outer cutter case holder in a static state.

In the case where the rotary electric shaver has three cutter units, there is a void among three inner cutter fall proof rings formed integrally with the cutter retaining plates. The void efficiently accommodates the pushup plate, the outer cutter float spring and the like coaxially on the central axis of the outer cutter frame. This arrangement is ideally suited to reduce the size of the head unit.

### BRIEF DESCRIPTION OF THE DRAWINGS

FIG. 1 is a perspective exterior view of a rotary electric shaver according to an embodiment of the present invention;

FIG. 2 is a sectional view taken at line II-II in FIG. 1;

FIG. 3 is an enlarged sectional view of a part of FIG. 2;

FIG. 4 is an exploded perspective view of a head unit:

FIG. 5 is an enlarged perspective view illustrating a part of a structure for holding an outer cutter case in FIG. 4;

FIG. 6 is a plan view illustrating the combination of an outer cutter frame and an outer cutter case assembly;

FIG. 7 is a sectional view taken at line VII-VII in FIG. 6;

FIG. 8 is a sectional view taken at line VIII-VIII in FIG. 6;

FIG. 9 is a sectional view taken at line IX-IX in FIG. 6;

FIG. 10 is an enlarged view of a part of FIG. 7;

FIG. 11 is a sectional view taken at a position corresponding to line VIII-VIII in FIG. 6, illustrating the structure in FIG. 8 to which an inner cutter has been added; and

FIG. 12 illustrates the head structure of a conventional example, wherein FIG. 12(A) is a plan view of the head structure, FIG. 12(B) is a sectional view taken at line B-B illustrating the head structure in a stationary state, and FIG. 12(C) is a sectional view taken at line B-B illustrating the head structure in a tilted state.

### DESCRIPTION OF THE PREFERRED EMBODIMENTS

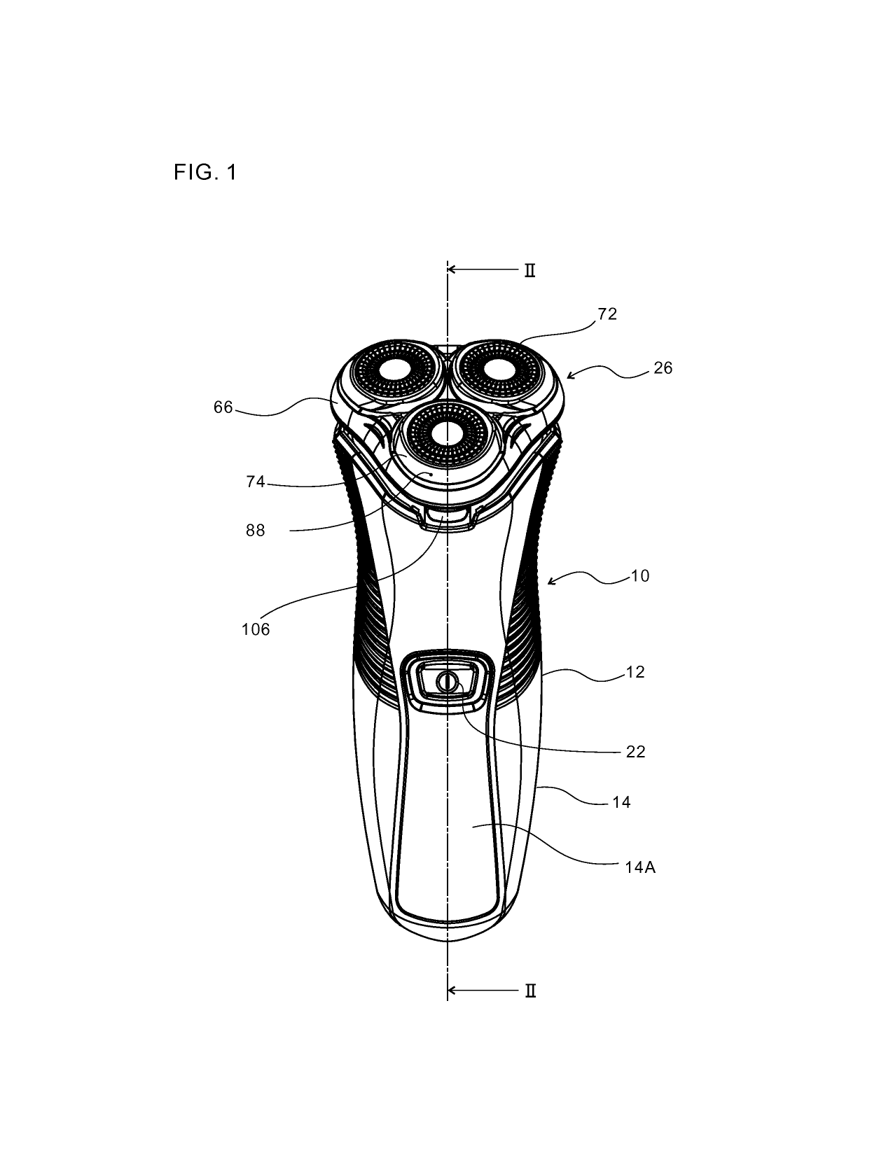

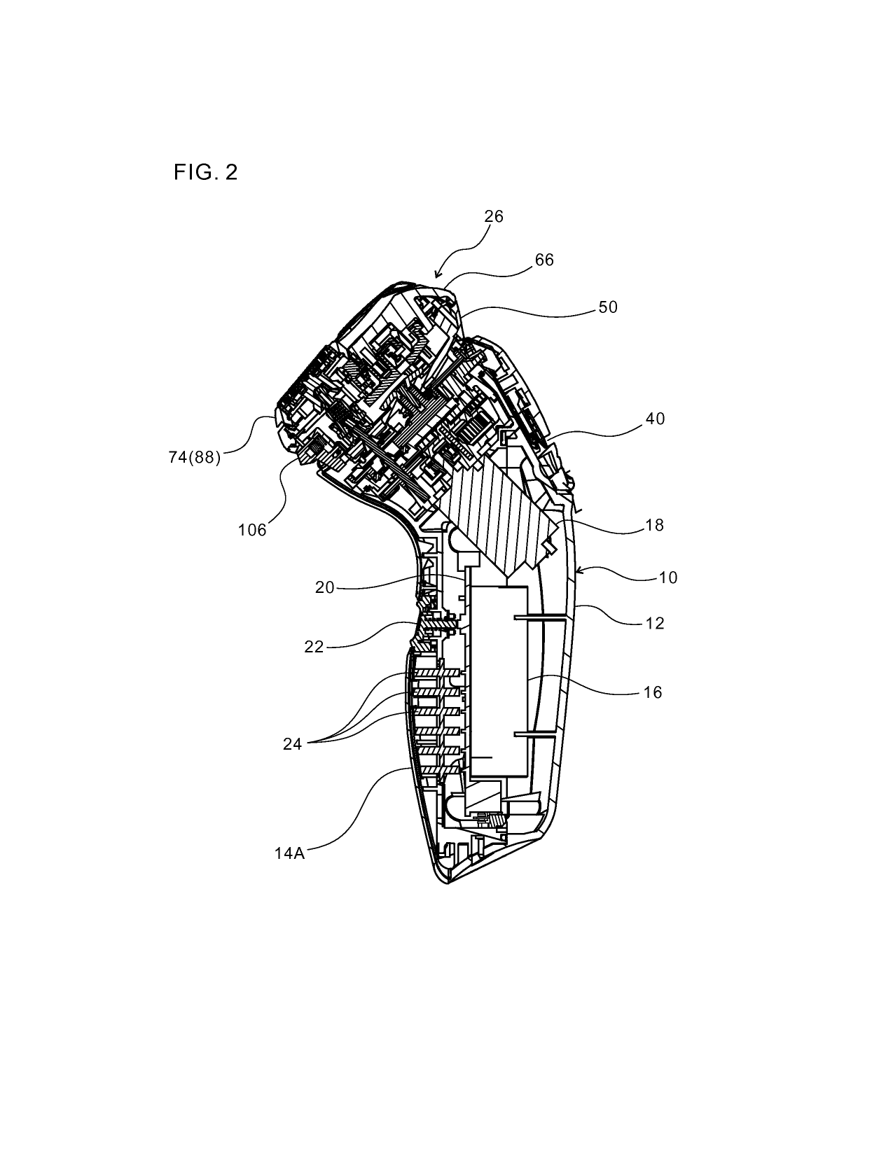

Referring to FIG. 1 to FIG. 3, a shaver main body 10 includes a case 14, in which a substantially columnar grip 12 has its upper portion bent obliquely upward toward the front. The case 14, the front and back of which can be separated, houses therein a chargeable battery 16, an electric motor 18, a control circuit board 20, and the like, as illustrated in FIG. 2. A power switch 22 is mounted on the front surface of the case 14. Below the switch 22, displays 24 composed of LED lamps indicating the remaining battery power level of the battery 16, an operation mode and the like are provided such that the displays 24 can be seen through a translucent portion 14A of the case 14.

A head unit 26 is openably and detachably mounted on the top of the case 14 such that the head unit 26 can be opened and closed. The head unit 26 is tilted relative to the grip 12 of the case 14 such that the shaving surface thereof (the upper surface of an outer cutter frame 66) is oriented obliquely upward to the front. The rotation output shaft of the electric motor 18 is oriented toward the head unit 26.

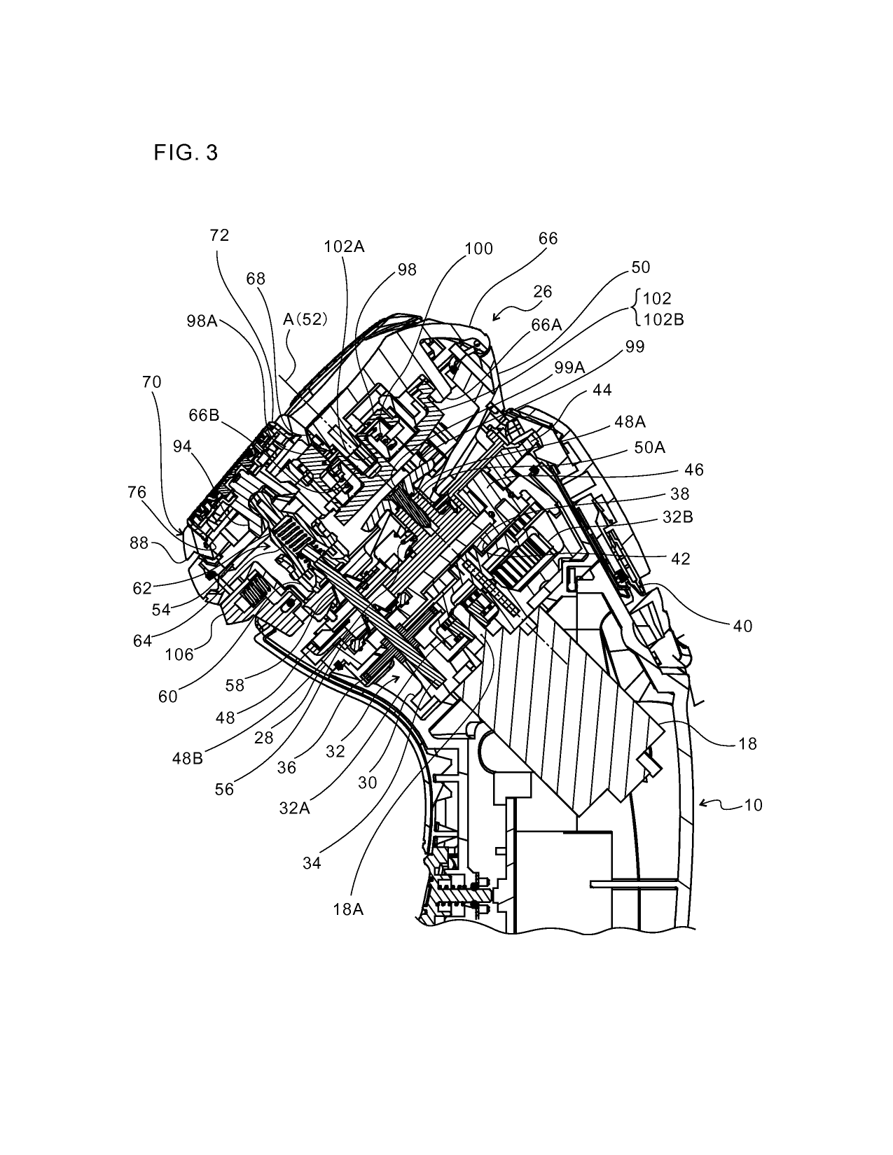

A reduction gear assembly 32 is placed between an inner top cover plate 28 covering the top of the main body 10 and an inner bottom cover plate 30 securing the electric motor 18, as illustrated in FIG. 3. The reduction gear assembly 32 reduces the rotational speed of a rotation output shaft 18A of the motor 18 by a small gear 32A and an inner cutter large gear 32B and transmits the reduced speed to three inner cutter drive shafts 34 through a large spur gear 36. The bottom end of each of the inner cutter drive shafts 34 is rotatably supported by the inner bottom cover plate 30, and the middle portion thereof penetrates the inner top cover plate 28 into the head unit 26.

The each of the large spur gears 36 secured to each of the three inner cutter drive shafts 34 meshes with a gear formed on the top surface of the inner cutter large gear 32B. An eccentric cylindrical cam 38 is formed integrally with the top surface of the inner cutter large gear 32B and drives an edge-trimming cutter 40. More specifically, a cam follower 42 engaging the cam 38 to rock is made integral with a supporting point portion 46 of a trimmer drive lever 44, which penetrates the inner top cover plate 28 and swings, and causes the trimmer drive lever 44 to laterally swing. When the edge-trimming cutter 40 is raised, the trimmer drive lever 44 is engaged in the edge-trimming cutter 40 to cause the edge-trimming cutter 40 to reciprocate.

A waterproof plate 48 is secured to the top surface of the inner top cover plate 28 of the main body 10, and a substantially bowl-shaped head holder 50 is retained above the waterproof plate 48 such that the head holder 50 is slightly pivotable. The aforesaid three inner cutter drive shafts 34 are positioned at the apexes of the equilateral triangle, the center of which is a central axis 52 of the head unit 26 (refer to A in FIG. 3 to FIG. 6). As described above, the bottom portions of the inner cutter drive shafts 34 are rotatably supported by the inner bottom cover plate 30, and the middle portions thereof extend upward, penetrating the inner top cover plate 28, the waterproof plate 48 and the head holder 50. Universal joints 54 are mounted on the upper ends of the inner cutter drive shafts 34.

Substantially conical flexible sealants 56 and 58 are installed between the inner cutter drive shafts 34 and the waterproof plate 48 and the head holder 50, as illustrated in FIG. 3. The universal joint 54 has a connecting drive shaft 60 secured to the upper end of the inner cutter drive shaft 34, a connecting driven shaft 62 slidably retained in an axial direction relative to the connecting drive shaft 60, and a coil spring 64 compressively installed between the drive shaft 60 and the connecting driven shaft 62. The connecting driven shaft 62 serves as the drive shaft for rotatively driving an inner cutter 90. The upper end of the connecting driven shaft 62 is provided with a spherical portion, the top plan view of which is substantially quadrangular. The spherical portion is inserted from below into a substantially quadrangular concavity and engages the concavity movably, i.e., tiltably, the concavity being opened downward and formed in a boss 94 of the inner cutter 90.

The head unit 26 will now be described. In the head unit 26, three cutter units are attached to the outer cutter frame 66, which can be opened upward and which is mounted on the head holder 50. The outer cutter frame 66 is substantially triangular as observed in the front view thereof, and the peripheral edge thereof is gradually curved downward. The outer cutter frame 66 has three annular mounting ports 68, as illustrated in FIGS. 3, 4 and 5. An outer cutter case assembly 70 is held in each of the mounting ports 68 through the intermediary of an outer cutter case holder 78, which will be discussed later, such that the outer cutter case assembly 70 is movable in the vertical direction and the pivoting direction.

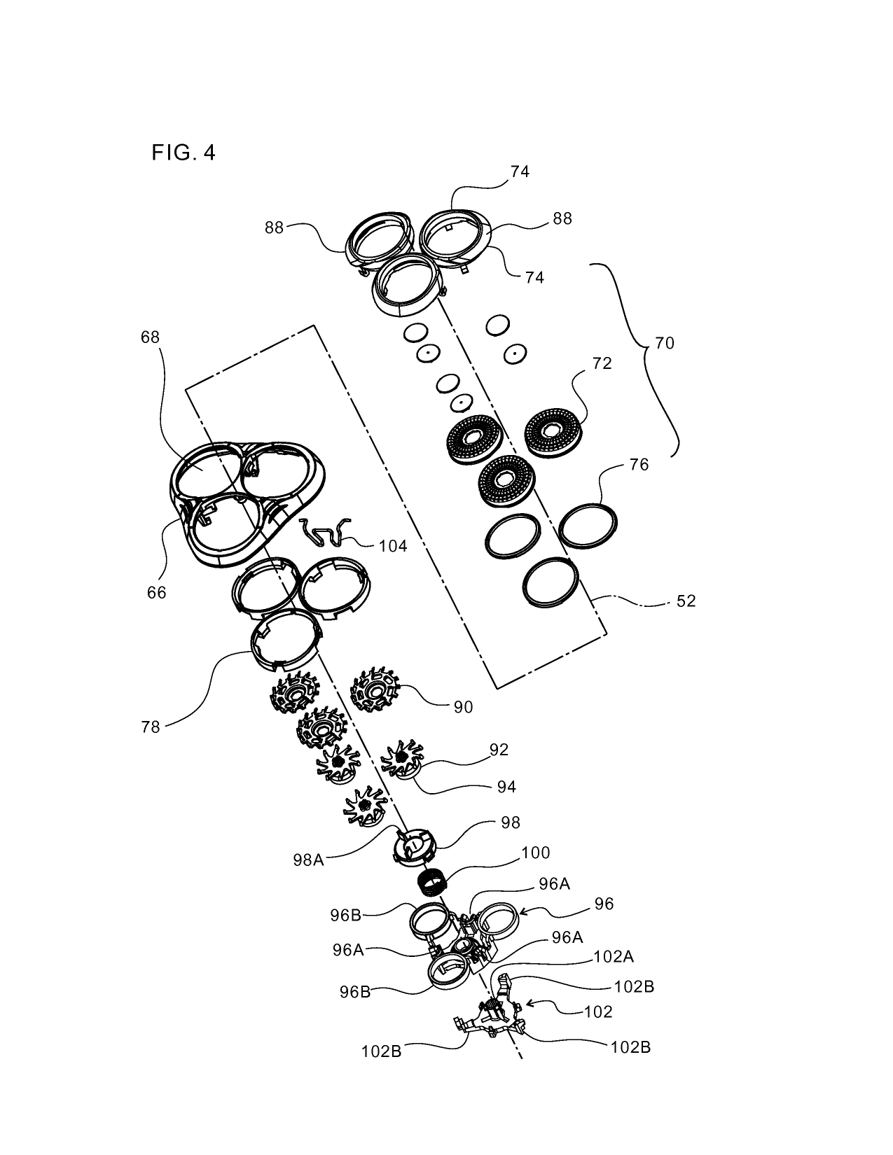

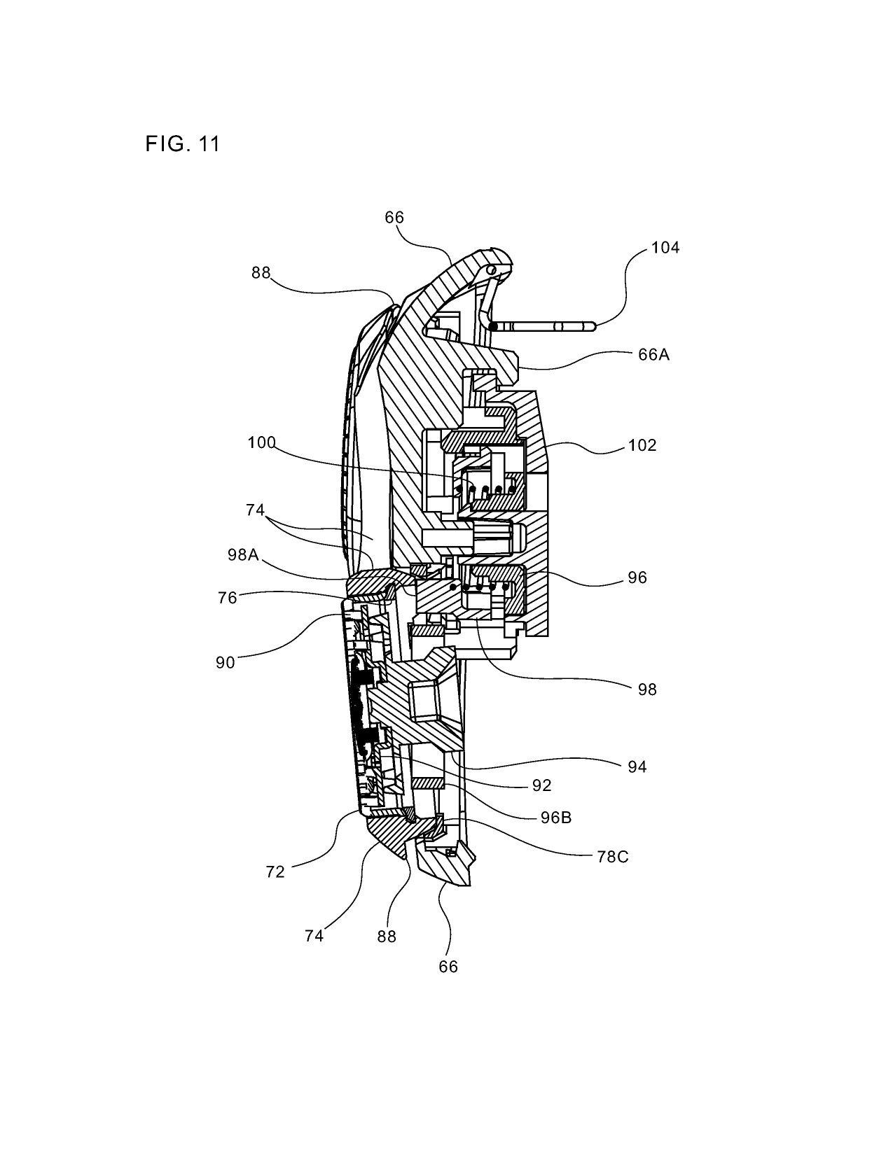

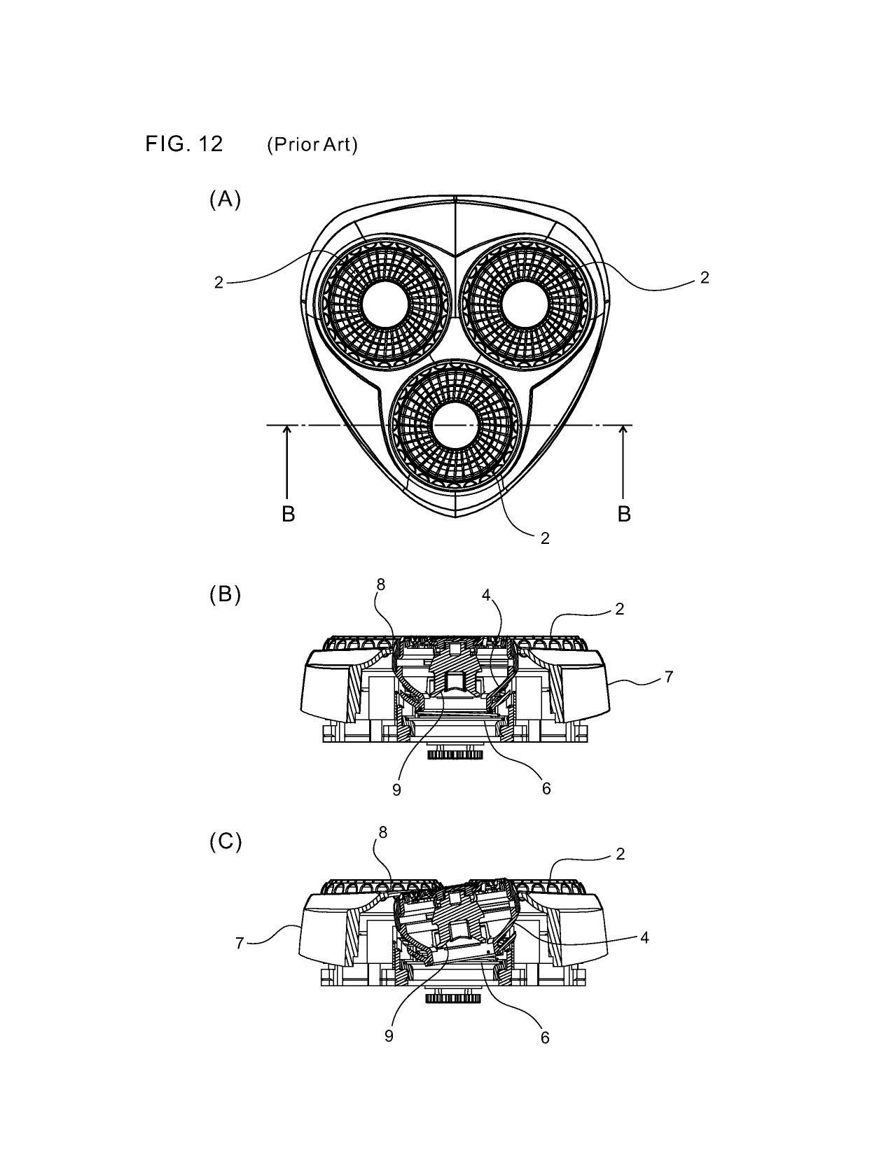

More specifically, the outer cutter assembly 70 includes an outer cutter 72 which is substantially discoid and the peripheral edge of which is bent downward, the annular outer cutter case 74 in which the outer periphery of the outer cutter 72 is fitted from below and secured, and an annular stopper ring 76 which is fitted in the inner periphery of the outer cutter case 74 to fix the outer cutter 72 to the outer cutter case 74 (refer to FIG. 4 and FIG. 11). The top surface of the outer cutter 72 has many hair introduction openings arranged in the radial direction and the top surface juts out slightly beyond the outer cutter case 74.

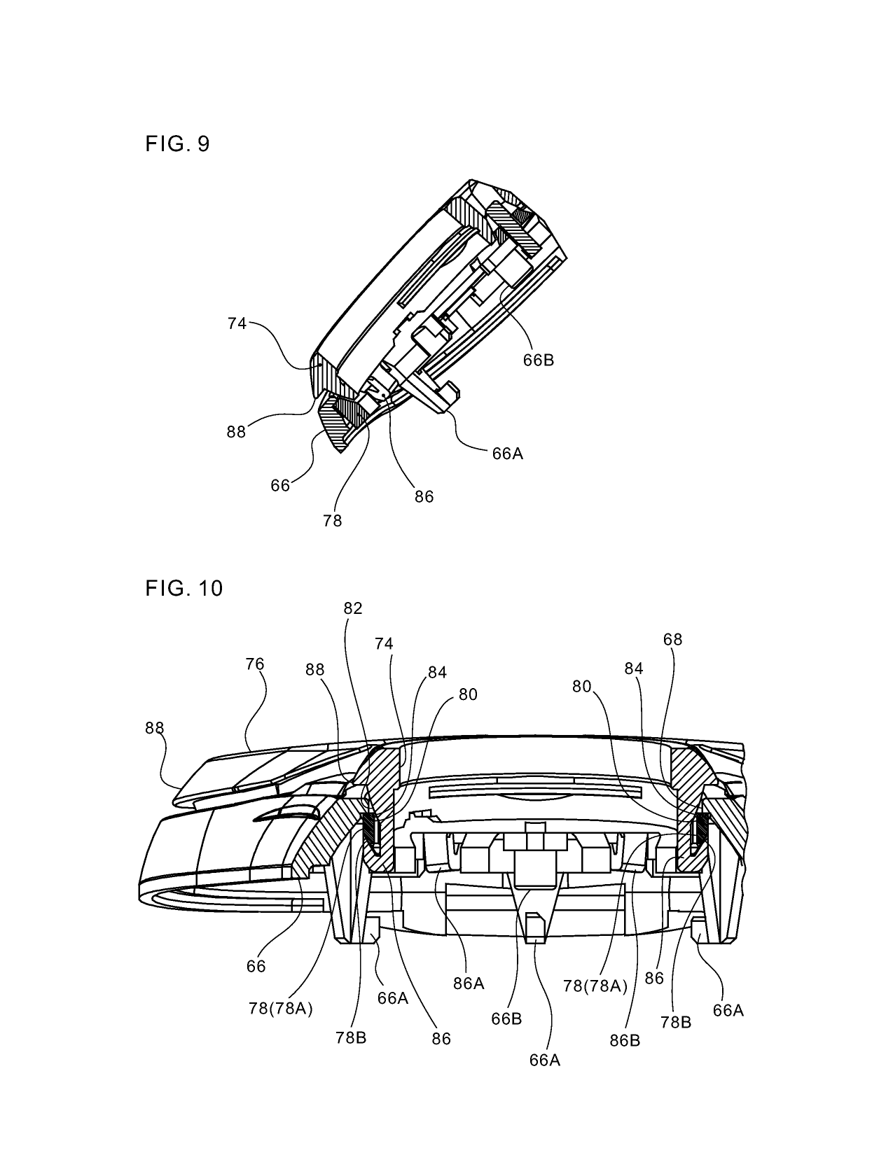

The annular outer cutter case holder 78 is fitted in the mounting port 68 of the outer cutter frame 66 to be vertically movable with the upper limit position thereof restrained. More specifically, as illustrated in FIGS. 4, 5 and 8 to 11, the outer cutter case holder 78 has a cylindrical outer periphery surface and is fitted from below into the mounting port 68 of the outer cutter frame 66 such that the outer cutter case holder 78 is vertically movable. The upper limit position of the outer cutter case holder 78 is restrained by abutting itself from below against a stepped portion 80 formed on an upper portion of the inner periphery of the mounting port 68, as illustrated in FIG. 10. Further, a spherical sliding surface 82 is formed on a lower portion of the outer periphery of the outer cutter case 74, as illustrated in FIG. 10, and a substantially mortar-shaped sliding surface 84, which comes in sliding contact with the spherical sliding surface 82, is formed on the upper portion of the inner periphery of the outer cutter case holder 78. With this arrangement, the spherical sliding surface 82 is guided by the sliding surface 84 of the outer cutter case holder 78, allowing the outer cutter case 74 to pivot back and forth and from side to side in all directions.

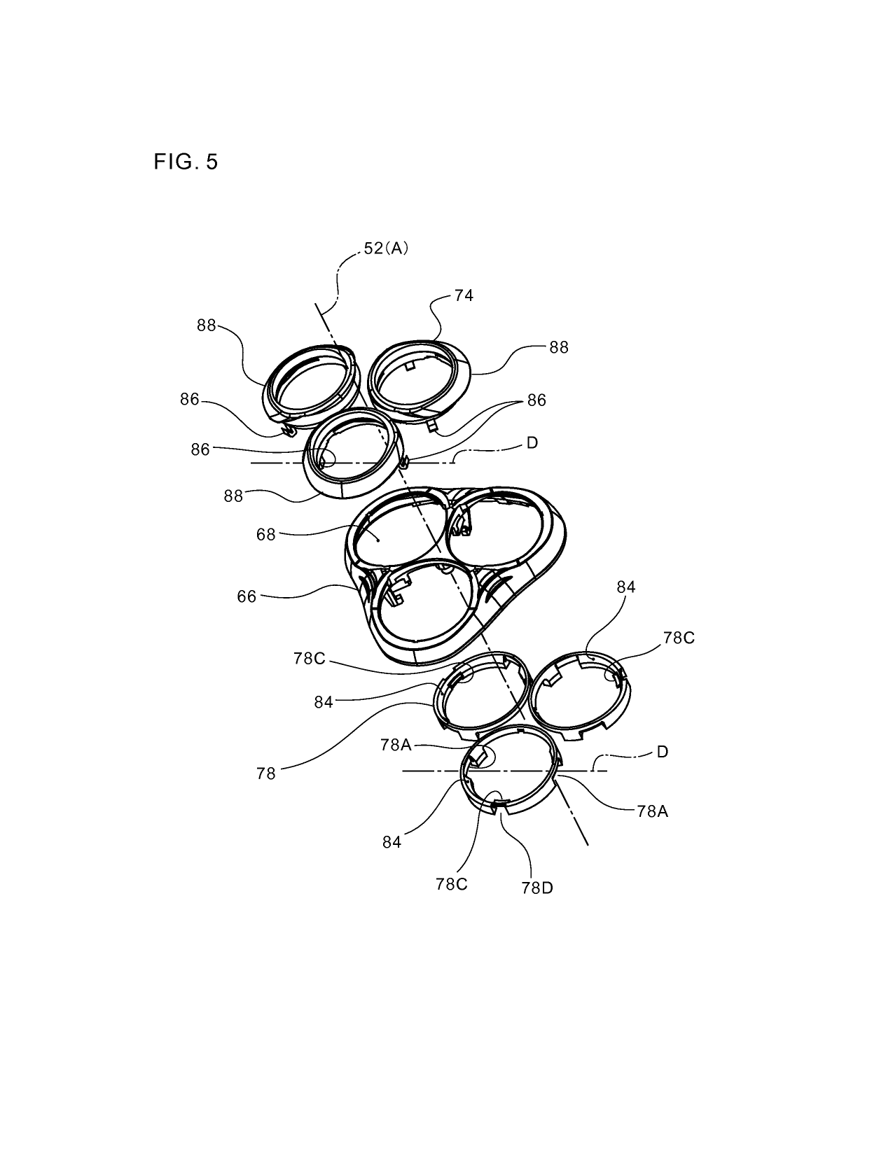

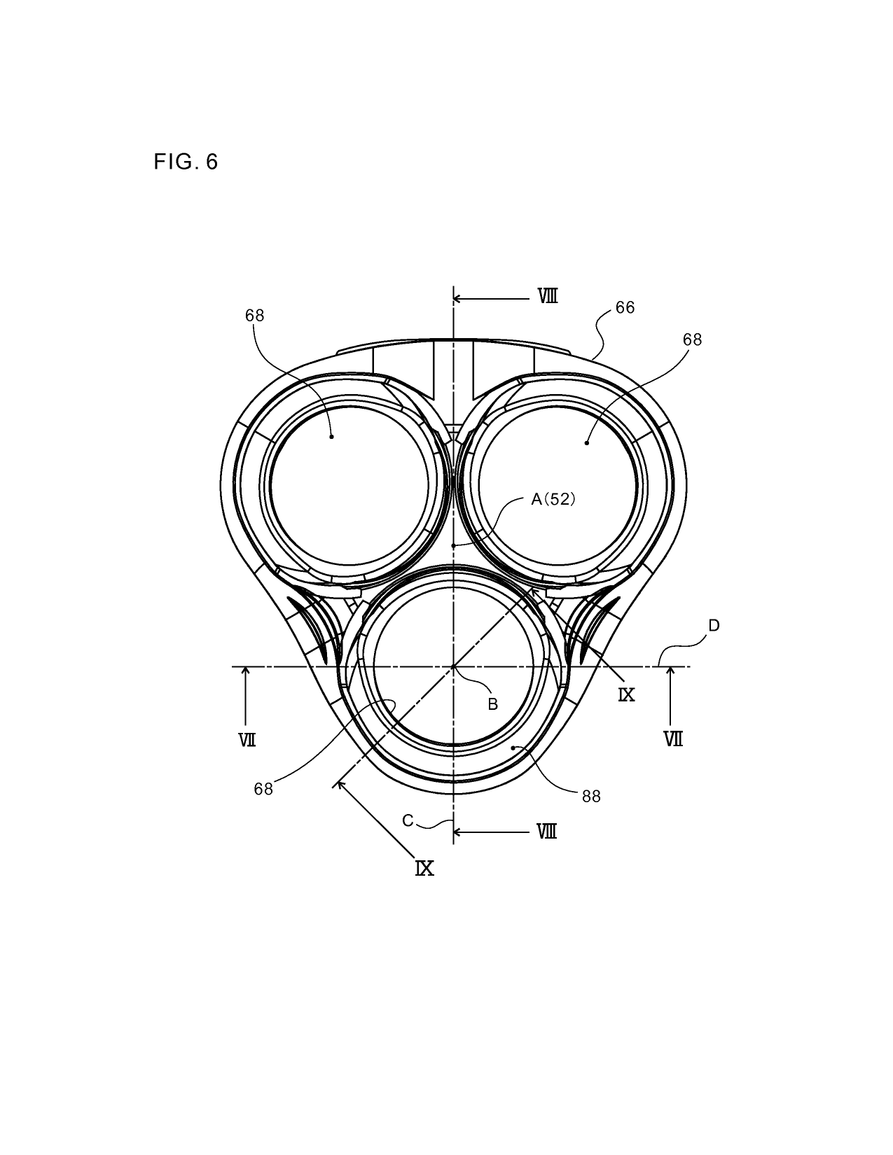

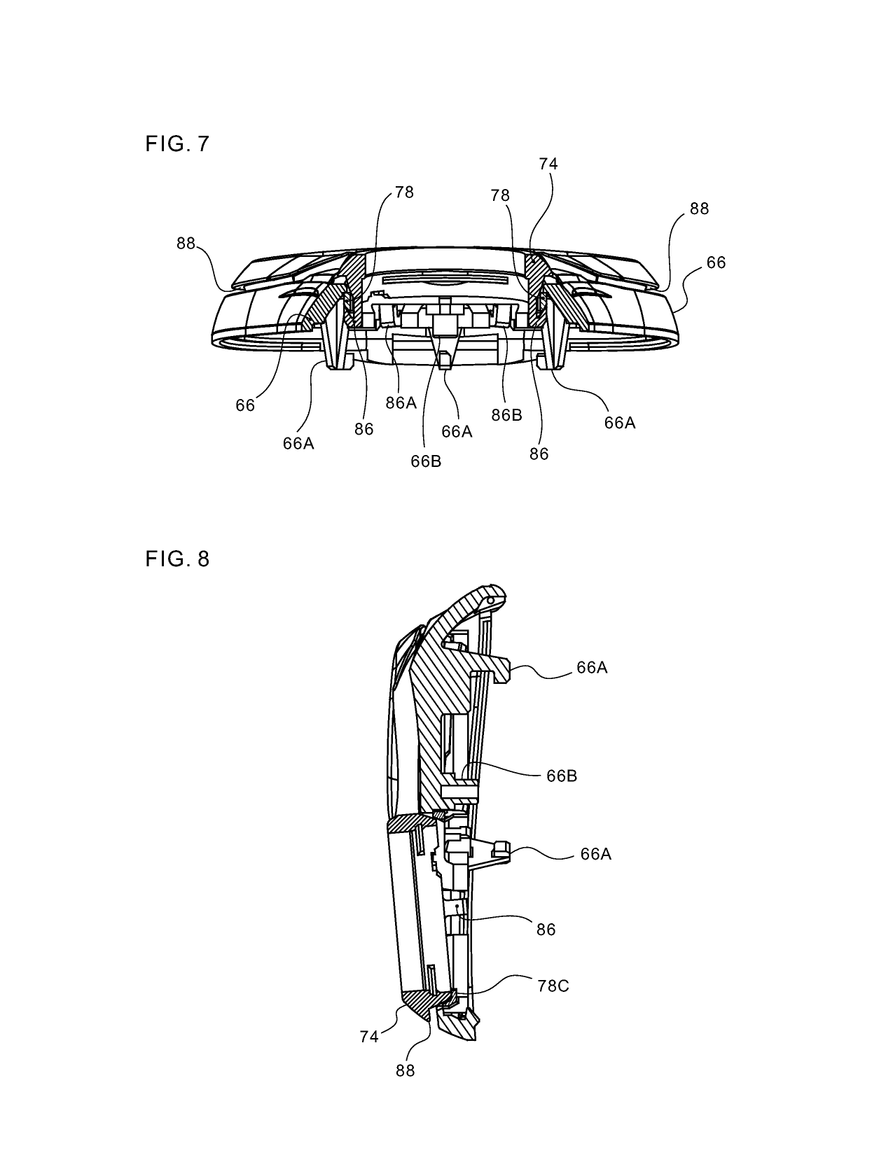

The outer cutter case 74 is provided with a pair of engaging hooks 86 jutting downward. The distal ends (bottom ends) of the engaging hooks 86 are folded outward, and the folded portions engage the bottom edge of the outer cutter case holder 78. As illustrated in FIGS. 5 and 6, the engaging hooks 86 are provided on a straight line (outer cutter pivoting axis) D which is orthogonal to a straight line C passing a center A of the outer cutter frame 66 and a center B of the mounting port 68 and which passes the center B of the mounting port 68, when observed in a plan view. Referring to FIGS. 7 and 10, an outer pair of engaging hooks 86 and 86 out of four engaging hooks 86, 86, 86A and 86B match the lower mounting port 68 in FIG. 6, while the inner two engaging hooks 86A and 86B match the upper left and the upper right mounting ports 68 and 68, respectively, in FIG. 6.

Cutouts 78A are formed on the straight line D (when observed in a plan view of FIG. 6) in the outer cutter case holder 78, as illustrated in FIGS. 5 and 10. The distal ends of the engaging hooks 86 engage the cutouts 78A from below. The lower portion of the outer periphery of the outer cutter case holder 78 has a substantially spherical sliding surface 78B formed thereon, as illustrated in FIG. 10. The distal ends of the engaging hooks 86 are in sliding contact with the spherical sliding surface 78B through the bottom of the outer periphery of the outer cutter case holder 78. The spherical sliding surface 78B is formed on a spherical surface that is concentric with the substantially mortar-shaped sliding surface 84 formed on the upper portion of the inner periphery of the outer cutter case holder 78. This allows the outer cutter case 74 to pivot back and forth and from side to side in all directions with respect to the outer cutter case holder 78. The outer cutter case 74 is also connected to the outer cutter case holder 78 in the vertical direction and vertically movable together with the outer cutter case holder 78.

As illustrated in FIGS. 5, 8 and 11, the outer cutter case holder 78 has a sliding surface, a side of which adjacent to the center A of the outer cutter frame 66 on line VIII-VIII (straight line C) in FIG. 6 is flushed with the mortar-shaped sliding surface 84. A tongue-shaped portion 78C against which the bottom edge of the outer cutter case 74 abuts is formed on the inner periphery of the cutout 78D on the opposite side of the outer cutter case holder 78.

A collar or brimmed convex portion (projection) 88, which juts out toward the upper surface of the outer cutter frame 66 (the top of the opening edge of the mounting port 68), is formed integrally with the outer periphery of the outer cutter case 74. The projection 88 serves as a stopper for preventing the outer cutter case 74 from excessively sinking into the mounting port 68. More specifically, as will be discussed hereinafter, the outer cutter case 74 is spring-urged upward by a pushup plate 98 (FIG. 4), which will be described later, at the side thereof adjacent to the center A of the outer cutter frame 66, while the inner cutter 90 is spring-urged upward at under the bottom surface of the outer cutter 72 by the drive shaft 62 (FIG. 3). Thus, the outer cutter case holder 78, which is connected to the outer cutter case 74 by the engaging hooks 86, is urged to be pulled upward and the upward travel thereof is restrained by abutting itself against the stepped portion 80 of the outer cutter frame 66 (FIG. 10). Meanwhile, the outer cutter case 74 is pivotably connected with the outer cutter case holder 78 by the engaging hooks 86, and the outer periphery thereof abuts against the tongue-shaped portion 78C provided on the outer cutter case holder 78, being pushed up by the outer cutter case holder 78 (FIGS. 8 and 11). At this time, the projection 88 of the outer cutter case 74 is separated upward from the top surface of the outer cutter frame 66.

Further, when depressing the outer cutter 72, if the outer cutter 72 is depressed at the side thereof adjacent to the center A of the outer cutter frame 66, then the outer cutter case 74 pivots about the straight line (pivoting axis) passing the engaging hooks 86. Firmly depressing the outer cutter 72 further causes the outer cutter case holder 78 to descend while compressing the pushup pate 98 and the drive shaft 62. Depressing the outer peripheral side of the outer cutter 72 descends while pushing the outer cutter case holder 78 down, since the bottom edge of the outer cutter case 74 abuts against the tongue-shaped portion 78C of the outer cutter case holder 78. The descent at this time is restricted by the projection 88 coming in contact with the top surface of the outer cutter frame 66.

The inner cutter 90 rotates in sliding contact with the inner surface of the outer cutter 72, thereby cutting hair introduced into the hair introduction openings of the outer cutter 72. The outer cutter 72 and the inner cutter 90 constitute the cutter unit. The inner cutter 90 is held by an inner cutter holder 92 attached to the bottom surface thereof, and the boss 94 secured to the inner cutter holder 92 has a concavity, which opens downward and into which the connecting driven shaft (also serving as the inner cutter drive shaft) 62 of the universal joint 54 is locked (FIGS. 3 and 11).

A cutter retaining plate 96 is detachably installed to the inner surface of the outer cutter frame 66. As illustrated mainly in FIGS. 3 and 4, the cutter retaining plate 96 retains the pushup plate 98, which elastically pushes up the outer cutter case 74 of the outer cutter case assembly 70. More specifically, the annular pushup plate 98 is mounted on a cylindrical guide formed at the center of the cutter retaining plate 96 with an outer cutter float spring 100 made of a coil spring interposed therebetween, thus abutting three vertical ribs 98A, which are protrusively provided at regular intervals on the top surface of the pushup plate 98, against the bottom surface of the outer cutter case 74 (FIGS. 3 and 4).

Thus, the three vertical ribs 98A abut against the outer cutter case 74 at the side thereof adjacent to the center A (the central axis 52) of the outer cutter frame 66. This causes a portion of each of the three outer cutter assemblies 70 adjacent to the center of the outer cutter frame 66 to be resiliently pushed up about each of the pivoting axes D. When the outer cutters 72 comes in contact with the skin to be depressed, the portions of the outer cutter assemblies 70 adjacent to the center of the outer cutter frame 66 sink around the pivoting axes D. At this time, the pushup plate 98 compresses the spring 100.

The cutter retaining plate 96 is detachably installed to the inner side of the outer cutter frame 66 by a Y-shaped removable plate 102. More specifically, a cylinder (collet) 102A with slits, which rotatably penetrates the guide at the center of the cutter retaining plate 96 (FIG. 3), is formed at the center of the removable plate 102 (FIG. 4). A hook provided at the distal end of the cylinder 102A is locked to the upper end of the guide. The distal ends of legs 102B of the removable plate 102 (FIG. 4), which radially extend, can be engaged with or disengaged from three fixed ribs 66A, which are protrusively provided on the inner surface of the outer cutter frame 66, in the circumferential direction.

Further, the cylinder 102A of the removable plate 102 engages a central projection 66B (FIGS. 3, 7, 8, 9 and 10) protrusively provided at the center of the bottom surface of the outer cutter frame 66 (on the central axis A) so as to position the removable plate 102. Three grooves 96A formed in the cutter retaining plate 96 (FIG. 4) engage the proximal portions of the fixed ribs 66A thereby to position the cutter retaining plate 96.

As illustrated in FIG. 3, the head holder 50 has an opening 50A opposing a boss 48A positioned at the center of the waterproof plate 48, and a capping member 99 comes in sliding contact with the top surface surrounding the opening 50A. The capping member 99 is secured to the boss 48A by screwing a screw 99A, which penetrates the capping member 99 from above, into the boss 48A. The central bottom surface of the head holder 50 is pressed upward by a coil spring 48B, which surrounds the boss 48A of the waterproof plate 48 and which is compressively interposed between the waterproof plate 48 and the boss 48A. As a result, the central portion of the head holder 50 is vertically sandwiched between the capping member 99 and the coil spring 48B, allowing the head holder 50 to pivot in a direction in which the central axis 52 tilts.

Three inner cutter fall proof rings 96B, each of which surrounds the boss 94 of the inner cutter 90 of the cutter unit, are integrally formed with the cutter retaining plates 96 (FIG. 4). These inner cutter fall proof rings 96B prevent the inner cutters 90 from falling off when the head unit 26 is attached or detached or opened or closed in a state wherein the three cutter units have been attached to the head unit 26 and the cutter retaining plates 96 have been secured to the outer cutter frame 66.

The head unit 26 constructed as described above is attached to the head holder 50 by a hinge 104 (FIGS. 4 and 11), so that the head unit 26 can be opened and closed. More specifically, the hinge 104, which is formed of a substantially U-shaped member swingably retained on the edge of the outer cutter frame 66, is held by inserting the hinge 104 into a slit formed in the head holder 50. A portion of the edge of the head holder 50 on the opposite side from the hinge 104 can be locked by a locking device 106 provided on the head holder 50 (FIGS. 1, 2 and 3).

In the present embodiment, the outer cutter case 74 of the outer cutter case assembly 70 can be pivoted longitudinally with the pivoting axis D (FIGS. 5 and 6) being the center of the pivoting, i.e., pivoting about the axis D, and also laterally pivoted (about an axis C) by the engaging hooks 86 and the sliding motion of the sliding surface of the outer cutter case holder 78. The side of the outer cutter case 74 adjacent to the center of the head (adjacent to the central axis 52) is resiliently pushed up by the ribs 98A of the pushup plate 98 (FIGS. 3, 4, 6 and 10). When, therefore, the top surface (the shaving surface) of the head unit 26 is pressed against the skin, the outer cutter case 74 pivots while pressing the pushup plate 98 down. At this time, if only one outer cutter case assembly 70 out of three assemblies is pressed down, then the pushup plate 98 merely tilts, exerting no influences on the forces for depressing the remaining outer cutter case assemblies 70. Thus, the three outer cutter assemblies 70 independently pivot without influencing each other, so that the three outer cutter case assemblies 70 do not interfere with each other in shaving performance.

Further, the top surface of the outer cutter frame 66 is exposed among the mounting ports 68 of the three outer cutter cases 74 (FIGS. 1, 5, 6 and 8). Hence, when the head unit 26 slides on the skin while one outer cutter case 74 is deeply down, a bulging portion of the skin is temporarily supported by the top surface of the outer cutter frame 66 between the sunken outer cutter case 74 and another outer cutter case 74 adjacent thereto. In other words, the difference in height between the adjacent outer cutter cases 74 is accommodated by the top surface of the outer cutter frame 66, thus allowing the head unit 26 to smoothly move.

What is claimed is:

1. A rotary electric shaver with a plurality of cutter units, each of which has an outer cutter and an inner cutter, the respective outer cutter being pivotably held at a mounting port of an outer cutter frame held on a main body, and the respective inner cutter being urged upward and rotated by a drive shaft while being in resilient contact with the bottom surface of the outer cutter, the rotary electric shaver comprising:
an outer cutter case which is secured to an outer periphery of the outer cutter and which has a spherical sliding surface formed on a lower portion of the outer periphery of the outer cutter case;
an outer cutter case holder which is fitted in the mounting port to be vertically movable with an upper limit position thereof restrained and which pivotably holds the outer cutter case, guiding the spherical sliding surface of the outer cutter case; and
a pushup plate which imparts an upward return tendency to an outer cutter case assembly formed of the outer cutter, the outer cutter case and the outer cutter case holder;
wherein at least a part of the outer periphery of the outer cutter case is provided with a projection which extends out to an upper surface of the outer cutter frame so as to serve as a stopper which prevents the outer cutter case from sinking into the mounting port.

2. The rotary electric shaver according to claim 1, wherein the outer cutter case has a plurality of engaging hooks extending downward, which is formed integrally with the outer cutter case, and distal ends of the engaging hooks engage the outer cutter case holder from below to connect the outer cutter case with the outer cutter case holder in a vertical direction such that the outer cutter case is pivotable in all directions with respect to the outer cutter case holder.

3. The rotary electric shaver according to claim 2, wherein the outer cutter case holder has a substantially mortar-shaped sliding surface on an upper portion of the inner periphery thereof and a spherical sliding surface on a lower portion of outer periphery thereof, the substantially mortar-shaped sliding surface being in sliding contact with the spherical sliding surface of the outer cutter case, and spherical sliding surface engaging with the engaging hooks and sliding in all pivoting directions.

4. The rotary electric shaver according to claim 2, wherein said plurality of cutter units are fitted in the outer cutter frame, each of the outer cutter cases of each of the cutter units is provided with a pair of engaging hooks on a straight line which is orthogonal to a straight line passing a center of the outer cutter frame and a center of the mounting port and which passes the center of the mounting port, as observed in a plan view, each of the outer cutter cases is pivotally connected onto each of the outer cutter case holders by the engaging hooks, and the projection is provided on an outer periphery side of the outer cutter frame of the outer cutter case.

5. The rotary electric shaver according to claim 4, wherein the pushup plate is abutted against a bottom surface of each of the outer cutter case holders on a central side of the outer cutter frame, and the pushup plate pushes up a portion of the outer cutter case assembly, which portion is adjacent to the center of the outer cutter frame, to the upper limit position of the outer cutter case holder, whereas the drive shaft pushes up the inner cutter at the vicinity of the center of the outer cutter so as to cause a part of the outer cutter case adjacent to the outer periphery of the outer cutter frame to be pushed up, causing the projection to be separate from the upper surface of the outer cutter frame in a static state.
